(19) United States
(12) Patent Application Publication
(10) Pub. No.: US 2012/0293636 A1
(43) Pub. Date: Nov. 22, 2012

(54) Automatic 3-Dimensional Z-Axis Settings

(75) Inventor: Ross Gilson, Philadelphia, PA (US)

(73) Assignee: COMCAST CABLE COMMUNICATIONS, LLC, Philadelphia, PA (US)

(21) Appl. No.: 13/110,988

(22) Filed: May 19, 2011

(51) Int. Cl. H04N 13/04

(52) U.S. Cl. 348/51; 348/E13.026

(57) ABSTRACT

Methods and structures related to generation of and display of on screen graphics, such as content, closed captioning, channel number, and volume bar, with 3D video content are described. A computing device may determine a z-axis depth to utilize for display of on screen graphics 3D video content. A video image of the 3D video content and the on screen graphics at the z-axis depth may be generated, and the generated video image may be outputted to a display device. In another example, frames of 3D video content and a z-axis setting profile may be received at a central facility for further processing. The z-axis setting profile may include a z-axis depth value for display of on screen graphics. The z-axis setting profile may be embedded with the frames of 3D video content into a video stream, and the video stream may be transmitted to a customer premises.

### BACKGROUND

The disclosure relates generally to 3-dimensional video, and some aspects of the present disclosure relate to transmission, receipt, and rendering of on screen graphics data for a 3-dimensional (3D) video environment.

Three-dimensional television, both content and products, is booming. More and more manufacturers are offering 3D televisions, video services are offering 3D content, and many theatrical releases are now available in 3D. With the growing popularity of 3D, there are many needs and opportunities to offer users an improved viewing experience.

### SUMMARY

In light of the foregoing background, the following presents a simplified summary of the present disclosure in order to provide a basic understanding of some features of the disclosure. This summary is provided to introduce a selection of concepts in a simplified form that are further described below. This summary is not intended to identify key features or essential features of the disclosure.

Systems and methods for display of on screen graphics, such as closed captioning, channel number, and volume bar, with 3D video content are described. A frame of 3D video content, a plurality of z-axis setting profiles associated with the frame, and a request to display on screen graphics with the frame of 3D video content may be received. A determination may be made for a first z-axis setting profile of the plurality of z-axis setting profiles to utilize for display of the on screen graphics with the frame, and the on screen graphics may be outputted in a first z-axis setting based upon a first 3D depth value of the determined first z-axis profile.

When a new frame is received, a determination may be made as to whether to modify a z-axis setting for on screen graphics for the new frame. Upon determining to modify the z-axis setting, a second z-axis setting profile of a new plurality of z-axis setting profiles to utilize for display of the on screen graphics with the new frame may be determined. Then, the on screen graphics may be outputted, with the new frame, in a second z-axis setting based upon a second 3D depth value of the determined second z-axis profile. Such a sequence may occur for each frame of 3D video content. With each frame of 3D video content there is an associated plurality of z-axis profile settings.

In accordance with another aspect of the present disclosure, a z-axis setting profile of a plurality of z-axis setting profiles for an associated frame of 3D video content may be determined based upon a rendering location of the on screen graphic on a display device, a change of time, 3D video content of the associated frame of 3D video content, an identity of a viewer, and/or a current channel being viewed.

In accordance with one or more other aspects of the present disclosure, a computing device may transmit frames of 3D video content and associated pluralities of z-axis setting profiles. A plurality of frames of 3D video content and a different plurality of z-axis setting profiles associated with each of the plurality of frames may be received. Each z-axis setting profile may include a z-axis depth value for display of a type of on screen graphics. The different plurality of z-axis setting profiles associated with each of the plurality of frames may be embedded with the plurality of frames of 3D video content into a video stream. Then, the video stream may be transmitted.

### BRIEF DESCRIPTION OF THE DRAWINGS

Some embodiments of the present disclosure are illustrated by way of example, and not by way of limitation, in the figures of the accompanying drawings and in which like reference numerals refer to similar elements.

FIG. 1 illustrates an example network for IP streaming of 3D video content in accordance with one or more aspects of the disclosure herein;

FIG. 2 illustrates an example home with various communication devices on which various features described herein may be implemented;

FIG. 3 illustrates an example computing device on which various features described herein may be implemented;

FIGS. 4A-4C illustrate examples of a 3D video content with different Z-axis depths in accordance with one or more aspects of the present disclosure;

FIG. 5A illustrates an example display screen in accordance with one or more aspects of the present disclosure;

FIG. 5B illustrates a z-axis depth for a on screen graphic in accordance with one or more aspects of the present disclosure;

FIG. 6 illustrates a block diagram of on screen graphics in accordance with one or more aspects of the present disclosure;

FIG. 7 is an illustrative flowchart of a method in accordance with one or more aspects of the disclosure herein;

FIG. 8 illustrates a flowchart of an example method in accordance with one or more aspects of the disclosure herein;

FIG. 9 illustrates a flowchart of an example method with a selected profile of z-axis settings in accordance one or more aspects of the disclosure herein;

FIG. 10 illustrates a flowchart of an example method in accordance with one or more aspects of the disclosure herein;

FIG. 11 illustrates a flowchart of an example method for in accordance with one or more aspects of the disclosure herein;

FIG. 12 illustrates a flowchart of an example method in accordance with one or more aspects of the disclosure herein; and

FIG. 13 is another illustrative flowchart of a method in accordance with one or more aspects of the disclosure herein.

### DETAILED DESCRIPTION

In the following description of the various embodiments, reference is made to the accompanying drawings, which form a part hereof, and in which is shown by way of illustration various embodiments in which features may be practiced. It is to be understood that other embodiments may be utilized and structural and functional modifications may be made.

Aspects of the disclosure may be operational with numerous general purpose or special purpose computing system environments or configurations. Examples of computing systems, environments, and/or configurations that may be suitable for use with features described herein include, but are not limited to, personal computers, server computers, hand-held or laptop devices, multiprocessor systems, microprocessor-based systems, set top boxes, digital video recorders, programmable consumer electronics, Internet connectable display devices, network PCs, minicomputers, mainframe computers, distributed computing environments that include any of the above systems or devices, and the like.

The features may be described and implemented in the general context of computer-executable instructions, such as program modules, being executed by one or more computers. Generally, program modules include routines, programs, objects, components, data structures, etc. that perform particular tasks or implement particular abstract data types. Features herein may also be practiced in distributed computing environments where tasks are performed by remote processing devices that are linked through a communications network. In a distributed computing environment, program modules may be located in both local and remote computer storage media including memory storage devices. Although the illustrative examples herein are described in relation to IP video or IP networks, concepts of the present disclosure may be implemented for any format or network environment capable of carrying 3D video content.

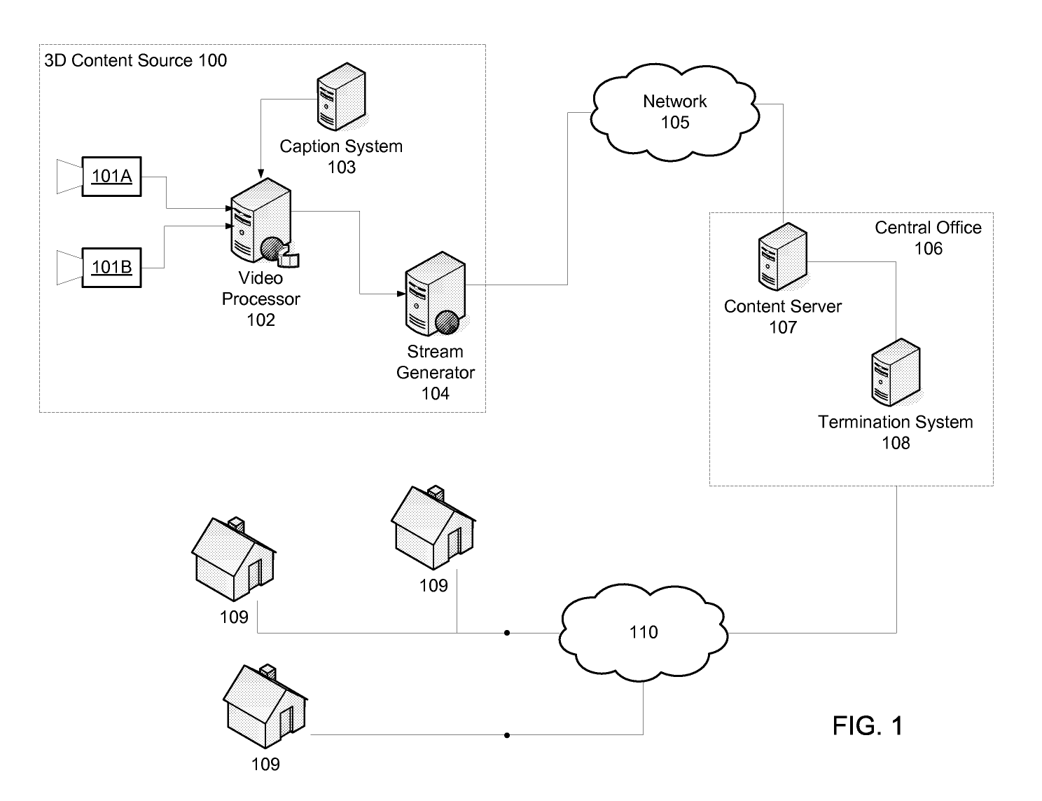

FIG. 1 illustrates an example network for IP streaming of 3D video content in accordance with one or more features of the disclosure. Aspects of the network allow for streaming of 3D video content over a packet switched network, such as the Internet (or any other desired public or private communication network). One or more aspects of the network may deliver 3D stereoscopic content to network connected display devices. Still other aspects of the network may adapt stereoscopic content to a variety of network interface devices and/or technologies, including devices capable of rendering two-dimensional (2D) and 3D content. Further aspects of the network may adapt stereoscopic content to a variety of distribution (e.g., channel) characteristics. Other aspects of the network adapt the graphics of an output device to 3D viewing preferences of a user.

Three-dimensional (3D) video content, such as pre-recorded or live 3D video content, may be created or offered by one or more 3D content sources 100. The sources 100 may capture video 3D content using one or more cameras 101A and 101B. Cameras 101A and/or 101B may be any of a number of cameras that are configured to capture video content. Other sources, such as storage devices or servers (e.g., video on demand servers) may be used as a source for 3D video content. In accordance with an aspect of the present disclosure, cameras 101A and 101B may be configured to capture video content for a left eye and a right eye, respectively, of an end viewer. The captured video content from cameras 101A and 101B may be used for generation of 3D video content for transmission to an end user. The data output from the cameras 101A and 101B may be sent to a stereographer/production (e.g., video processing) system 102 for initial processing of the data. Such initial processing may include any of a number of processing of such video data, for example, cropping of the captured data, color enhancements to the captured data, and association of audio and metadata to the captured video content.

An optional caption insertion system 103 may provide closed-captioning data accompanying video from the cameras. The closed-captioning data may, for example, contain textual transcripts of spoken words in an audio track that accompanies the video stream. Captioning insertion system 103 may provide textual and/or graphic data that may be inserted, for example, at corresponding time sequences to the data from the stereographer/production system 102. For example, data from the stereographic/production system 102 may be 3D video content corresponding to a stream of live content of a sporting event. Caption insertion system 103 may be configured to provide captioning corresponding to audio commentary of a sports analyst made during the live sporting event, for example, and processing system 102 may insert the captioning to one or more video streams from cameras 101A,B. Alternatively, the captioning may be provided as a separate stream from the video stream. Textual representations of the audio commentary of the sports analyst may be associated with the 3D video content by the caption insertion system 103. Data from the captioning system 103 and/or the video processing system 102 may be sent to a stream generation system 104, to generate a digital datastream (e.g., an Internet Protocol stream) for an event captured by the cameras 101A,B.

The stream generation system 104 may be configured to multiplex two streams of captured and processed video data from cameras 101A and 101B into a single data signal, which may be compressed. The caption information added by the caption insertion system 103 may also be multiplexed with these two streams. As noted above, the generated stream may be in a digital format, such as an IP encapsulated format. Stream generation system 104 may be configured to encode the 3D video content for a plurality of different formats for different end devices that may receive and output the 3D video content. As such, stream generation system 104 may be configured to generate a plurality of Internet protocol (IP) streams of encoded 3D video content specifically encoded for the different formats for rendering. For example, one of the IP streams may be for rendering the 3D video content on a display being utilizing by a polarized headgear system, while another one of the IP streams may be for rendering the 3D video content on a display being utilized by an anaglyph headgear system. In yet another example, a source may supply two different videos, one for the left eye and one for the right eye. Then, an end device may take those videos and process them for separate viewing. Any of a number of technologies for viewing rendered 3D video content may be utilized in accordance with the concepts disclosed herein. Although anaglyph and polarized headgear are used as examples herein, other 3D headgear types can be used as well, such as active shutter and dichromic gear.

The single or multiple encapsulated IP streams may be sent via a network 105 to any desired location. The network 105 can be any type of communication network, such as satellite, fiber optic, coaxial cable, cellular telephone, wireless (e.g., WiMAX), twisted pair telephone, etc., or any combination thereof (e.g., a hybrid fiber coaxial (HFC) network). In some embodiments, a service provider's central office 106 may make the content available to users. The central office 106 may include, for example, a content server 107 configured to communicate with source 100 via network 105. The content server 107 may receive requests for the 3D content from a user, and may use termination system, such as a modem termination system 108 to deliver the content to users 109 through a network of communication lines 110. The termination system 108 may be, for example, a cable modem termination system operating according to a standard. In an HFC network, for example, components may comply with the Data Over Cable System Interface Specification (DOCSIS), and the network of communication lines 110 may be a series of coaxial cable and/or hybrid fiber/coax lines. Alternative termination systems may use optical network interface units to connect to a fiber optic communication line, digital subscriber line (DSL) interface circuits to connect to a twisted pair telephone line, satellite receiver to connect to a wireless satellite line, cellular telephone transceiver to connect to a cellular telephone network (e.g., wireless 3G, 4G, etc.), and any other desired termination system that can carry the streams described herein.

A home of a user, such as the home 201 described in more detail below, may be configured to receive data from network 110 or network 105. The home of the user may include a home network configured to receive encapsulated 3D video content and distribute such to one or more viewing devices, such as televisions, computers, mobile video devices, 3D headsets, etc. The viewing devices, or a centralized device, may be configured to adapt graphics of an output device to 3D viewing preferences of a user. For example, 3D video content for output to a viewing device may be configured for operation with a polarized lens headgear system. As such, a viewing device or centralized server may be configured to recognize and/or interface with the polarized lens headgear system to render an appropriate 3D video image for display.

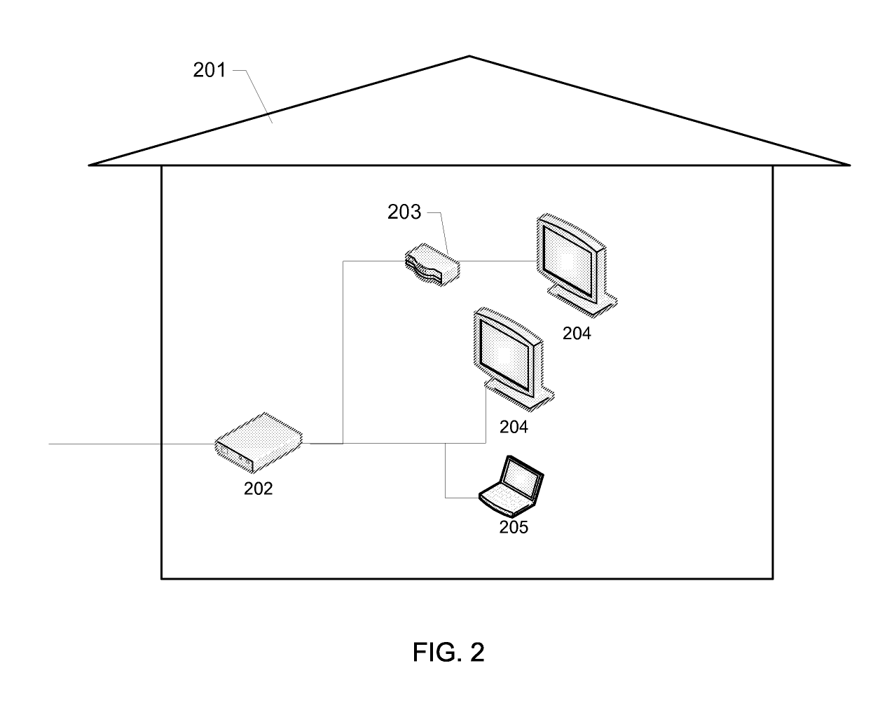

FIG. 2 illustrates a closer view of a premise 201, such as a home, that may be connected to an external network, such as the network in FIG. 1, via an interface. An external network transmission line (coaxial, fiber, wireless, etc.) may be connected to a home gateway device, e.g., content reception device, 202. The gateway 202 may be a computing device configured to communicate over the network 110 with a provider's central office 106.

The gateway 202 may be connected to a variety of devices within the home, and may coordinate communications among those devices, and between the devices and networks outside the home 201. For example, the gateway 202 may include a modem (e.g., a DOCSIS device communicating with a CMTS), and may offer Internet connectivity to one or more computers within the home. The connectivity may also be extended to one or more wireless routers 203. For example, a wireless router may be an IEEE 802.11 router, local cordless telephone (e.g., Digital Enhanced Cordless Telephone—DECT), or any other desired type of wireless network. Various wireless devices within the home, such as a DECT phone (or a DECT interface within a cordless telephone), a portable media player, and portable laptop computer, may communicate with the gateway 202 using a wireless router 203.

The gateway 202 may also include one or more voice device interfaces, to allow the gateway 202 to communicate with one or more voice devices, such as telephones. The telephones may be a traditional analog twisted pair telephone (in which case the gateway 202 may include a twisted pair interface), or it may be a digital telephone such as a Voice Over Internet Protocol (VoIP) telephone, in which case the phone may simply communicate with the gateway 202 using a digital interface, such as an Ethernet interface.

The gateway 202 may communicate with the various devices within the home using any desired connection and protocol. For example, an in-home MoCA (Multimedia Over Coax Alliance) network may use a home's internal coaxial cable network to distribute signals to the various devices in the homes. Alternatively, some or all of the connections may be of a variety of formats (e.g., MoCA, Ethernet, HDMI, DVI, twisted pair, etc.), depending on the particular end device being used. The connections may also be implemented wirelessly, using local wi-fi, WiMax, Bluetooth, or any other desired wireless format.

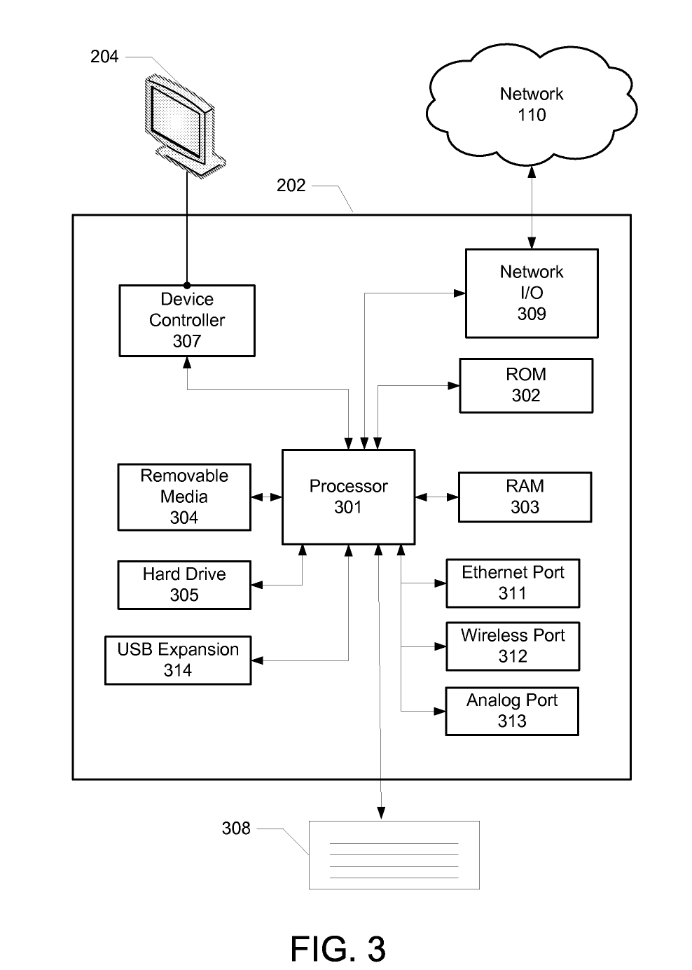

The gateway 202, which may comprise any processing, receiving, and/or displaying device, such as one or more televisions, set-top boxes (STBs), digital video recorders (DVRs), gateways, etc., can serve as a network interface between devices in the home and a network, such as the networks illustrated in FIG. 1. Additional details of an example gateway 202 are shown in FIG. 3, discussed further below. The gateway 202 may receive content via a transmission line (e.g., optical, coaxial, wireless, etc.), decode it, and may provide that content to users for consumption, such as for viewing 3D video content on a display of an output device 204, such as a 3D ready monitor. Alternatively, televisions, or other viewing output devices 204, may be connected to the network's transmission line directly without a separate interface device, and may perform the functions of the interface device or gateway. Any type of content, such as video, video on demand, audio, Internet data etc., can be accessed in this manner.

FIG. 3 illustrates a computing device that may be used to implement the network gateway 202, although similar components (e.g., processor, memory, computer-readable media, etc.) may be used to implement any of the devices described herein. The gateway 202 may include one or more processors 301, which may execute instructions of a computer program to perform any of the features described herein. Those instructions may be stored in any type of computer-readable medium or memory, to configure the operation of the processor 301. For example, instructions may be stored in a read-only memory (ROM) 302, random access memory (RAM) 303, removable media 304, such as a Universal Serial Bus (USB) drive, compact disc (CD) or digital versatile disc (DVD), floppy disk drive, or any other desired electronic storage medium. Instructions may also be stored in an attached (or internal) hard drive 305.

The gateway 202 may include or be connected to one or more output devices, such as a display 204 (or an external television that may be connected to a set-top box), and may include one or more output device controllers 307, such as a video processor. There may also be one or more user input devices 308, such as a wired or wireless remote control, keyboard, mouse, touch screen, microphone, etc. The gateway 202 may also include one or more network input/output circuits 309, such as a network card to communicate with an external network and/or a termination system 108. The physical interface between the gateway 202 and a network, such as the network illustrated in FIG. 1 may be a wired interface, wireless interface, or a combination of the two. In some embodiments, the physical interface of the gateway 202 may include a modem (e.g., a cable modem), and the external network may include a television content distribution system, such as a wireless or an HFC distribution system (e.g., a DOCSIS network).

The gateway 202 may include a variety of communication ports or interfaces to communicate with the various home devices. The ports may include, for example, Ethernet ports 311, wireless interfaces 312, analog ports 313, and any other port used to communicate with devices in the home. The gateway 202 may also include one or more expansion ports 314. The expansion ports 314 may allow the user to insert an expansion module to expand the capabilities of the gateway 202. As an example, the expansion port may be a Universal Serial Bus (USB) port, and can accept various USB expansion devices. The expansion devices may include memory, general purpose and dedicated processors, radios, software and/or I/O modules that add processing capabilities to the gateway 202. The expansions can add any desired type of functionality, several of which are discussed further below.

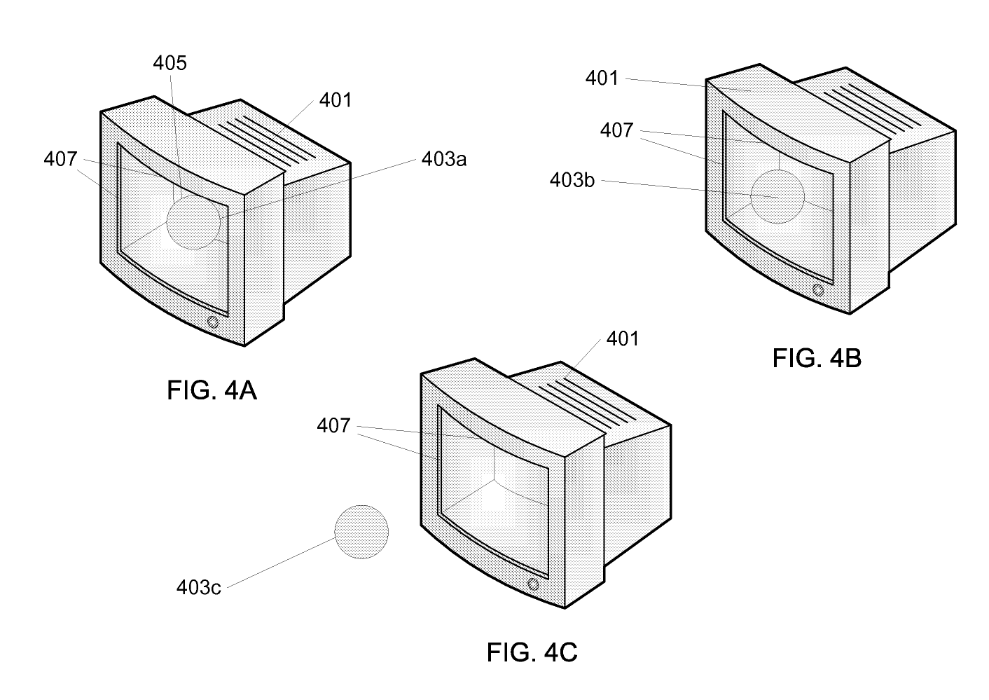

Turning now to 3D video, the depth or 3-axis component of a 3D video image provides a viewer with an enhanced viewing experience. By adding defined z-axis depth values for on screen graphics being used within a 3D environment, content providers may provide users an enhanced and customized 3D user experience based on individual user preferences. The z-axis depth refers to how close the on screen graphics will appear to be to a viewing user. On screen graphics, such as portions of content, a channel number or name, electronic guide menus, closed captioning, volume bars, etc., are one type of feature currently offered in 2D video, but which can benefit from 3D capabilities. FIGS. 4A-4C illustrate three examples of a 3D video content 403a, 403b, and 403c, respectively, with different Z-axis depths. In FIG. 4A, a display device 401 is shown rendering a 3D video content 403a. FIG. 4A illustrates an example where the 3D video content 403a appears to be located within the display device 401, or behind the surface of the display device. Visually, 3D video content 403a appears sunken toward an imaginary back wall 405 of the display device 401 in comparison to a display edge 407. In this example, 3D video content 403a visually appears to be behind the display edge 407. As described herein, the visual appearance of being behind the display edge 407 may be described as having a negative depth value, e.g., <0, for a depth of the 3D video content 403a. In FIG. 4B, display device 401 is shown rendering 3D video content 403b. FIG. 4B illustrates an example where the 3D video content 403b appears to be located right at the display edge 407 (or screen surface) of the display device 401. As described herein, the visual appearance of being at the display edge 407 of the display device 401 may be described as having a neutral depth value, e.g., 0, for a depth of the 3D video content 403b. FIG. 4C illustrates an example where the 3D video content 403C appears to be projecting out of the display device 401. Visually, 3D video content 403c appears to be in front of the display device 401 in comparison to a display edge 407. In this example, 3D video content 403c visually appears to be in front of the display edge 407. As described herein, the visual appearance of being in front of the display edge 407 may be described as having a positive value, e.g., >0, for a depth of the 3D video content 403c.

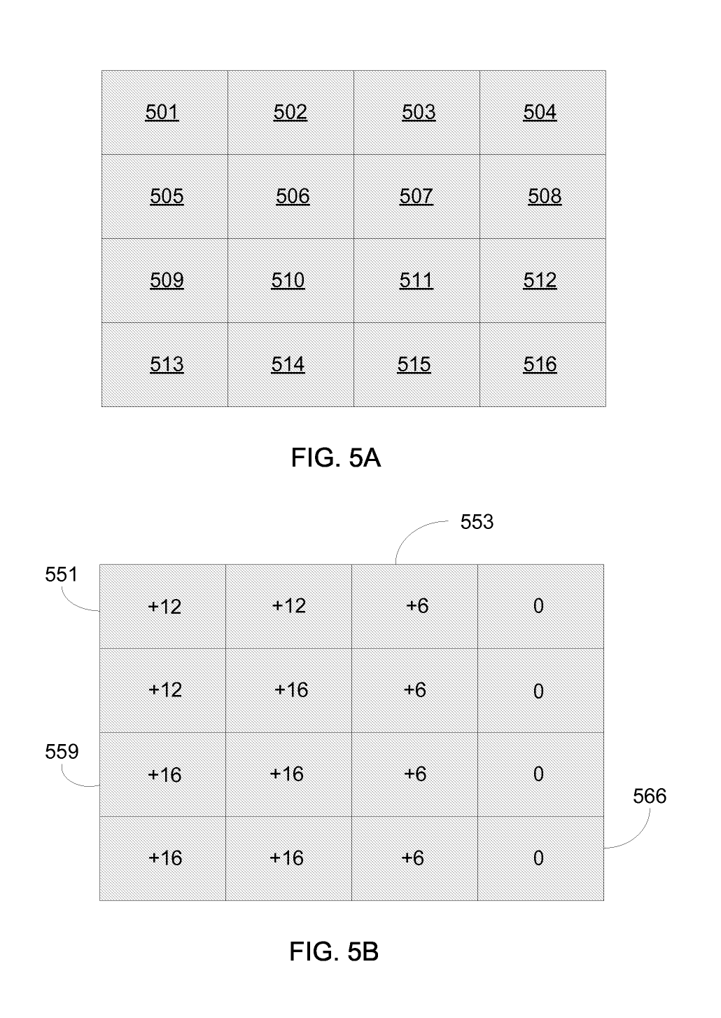

Embedded in a video stream transmission of 3D video content may be a number of z-axis setting profiles. Such profiles may be general settings, or may be with granularity potentially down to a per frame basis of 3D video content. Such z-axis setting profiles define the position of on screen graphics, which may be generated at a user end, for several or a respective frame of the 3D video content. Illustrative profiles are described below with respect to FIG. 5.

For each frame of 3D video content received at an end user device, on screen graphics may be affected differently. Aspects of the present disclosure may modify the z-axis position of on screen graphics within a 3D environment by accounting for any of a number of different variables for a respective video frame of 3D video content. In some conditions, a frame of 3D video content may not be suitable for a default positioning (e.g., for closed captioning text) within the 3D environment. For example, all of the 3D content of the 3D environment may be displayed on an output device, such as a television display, as appearing to be well outside of the output device, e.g., visually appearing to be located well in front of the front screen edge of the output device toward a viewer at an extreme. A default z-axis setting for content portions, for example for closed captioning text, may position the text to appear right at the screen edge of the display device. This depth may have a z-axis setting of 0. In such a case, the closed captioning text may create eye strain for a user in being able to see the text with respect to other 3D environment, as the user's eyes try to adjust to having 3D objects close to his/her face and content such as captioning text farther from the face. Attempting to overlay something at a depth lower than the 3D content that is immediately around may cause eye strain. The 3D video content currently being displayed as part of the frame, as well as other factors, can be taken into account for lowering the eye strain of the user or for creating an enhanced viewing experience for the user.

Each frame of 3D video content may have a plurality of available z-axis setting profiles for use in displaying on screen graphics with the respective frame. The plurality of z-axis setting profiles may represent all possible z-axis settings for on screen graphics with respect to a frame of 3D video content. As such, a default onscreen graphic depth setting can change per frame of 3D video content. A default setting for an on screen graphic may be a setting that is determined to have least eye strain on a viewer, taking into account, for example, the depths of other objects in the scene. As such, the specific location of the on screen graphic, such as a channel number in a corner of a screen, may change per frame to account for the least eye strain on a viewer. Within each profile, depth profile data for different types of on screen graphics may be included. For example, an on screen graphic for a channel number may have a depth value to pop out slightly further than closed captioning on screen graphic would, and these can be at a different depth of another on screen graphics, such as an electronic programming guide. So, within each profile, different classes of on screen graphics and associated z-axis depths may be included.

In one example, a number of different z-axis settings may be included as profiles for different portions of a display screen, based on the 3D depth of objects in those portions of the screen. FIG. 5A illustrates an example display screen segmented into different regions 501-516. Although 16 different regions of a display screen are shown in the example of FIG. 5A, it is understood that fewer or more regions of a display screen may be segmented accordingly. As shown, a display screen may be segmented into 16 different regions 501-516. In this example, a z-axis setting may exist for each region. A profile may exist for each region or there may be one profile that defines the z-axis depths per more than one (e.g., a group) or all regions. FIG. 5B illustrates an example profile of a matrix with different depth values for the respective different regions. FIG. 5B illustrates an allowable z-axis depth, for example, for a locally generated on screen graphic, in one or more regions of a display screen. The allowable z-axis depth may be a range, such as 12+/−6, since the minimum depth may be considered as well. In some embodiments, although users may adjust outside of the ranges in FIG. 5B, there may need to be a switch to a different profile for a different depth setting.

In still other examples, illustrative profiles may include a profile of a single bit that defines a z-axis depth for on screen graphics. A profile may be a single bit or a packet of bits of data. In the example of a single bit of data, the profile may be one of two options for depth and the single bit may define the depth for any on-screen graphics. In the example of a packet of bits of data, the data may include a first portion defining a maximum allowable depth value, a second portion defining a minimum depth value, a third portion defining an average of a maximum depth and a current 3D video content depth, and a fourth portion defining an average of a minimum depth and a current 3D video content depth and/or a fifth portion defining a preferred value

The matrix shown in FIG. 5B may be a maximum depth profile for a particular frame of 3D video content. The matrix profile in FIG. 5B illustrates that if an on screen graphic is to be rendered with a frame of 3D video content associated with this profile, the maximum allowable z-axis depth for the region 501 of a display screen in FIG. 5A is +12. If the scale for z-axis depth is between −16 and +16, one reason for the maximum allowable depth, may be that 3D video content being rendered in that region 501 of the display screen may be at a depth where anything more than +12 z-axis depth for an on screen graphic would create eye strain for a viewer. Differently, as shown with respect to regions 513, 503, and 516, in FIG. 5A, the maximum allowable z-axis depths may be +16, +8, and 0, respectively. Any of a number of different z-axis depths may be included in a profile and a profile may exist for minimum allowable z-axis depth, and others as described herein. Still further, a profile may include a file that lists a timestamp value, or a frame identifier, and a z-axis depth setting for each region.

For example, the 3D video content corresponding to the FIG. 5B matrix may have onscreen objects in the upper-left corner that appear very close to the user's face (e.g., having the +12 value), while objects in the lower right hand corner appear as farther away (having a negative value). An on screen graphic appearing in either of those corners may have different z-axis default graphic settings to compensate for the differences in depth. Therefore, if the on screen graphic is a channel number that is arranged to be shown in the upper left hand corner, that on screen graphic may have a z-axis depth adjusted by the +12 value, but if it were displayed in the lower right hand corner of the display screen instead, it would have a different z-axis depth (adjusted by the zero value instead).

Z-axis settings may have values for display of on screen graphics within the 3D environment. In accordance with one aspect of the present disclosure, a scale from −16 to +16 may be utilized to define a value. A z-axis setting value of 0 may correlate to visually appearing to be right at the display screen edge (e.g., as a 2D image would appear on the display screen). A positive value setting (e.g., +1 to +16) for a z-axis value may correlate to visually appearing to be in front of the edge of the display screen. A value of +1 may visually appear to be just in front of the display screen edge while a value of +16 may visually appear to be very much in front of the edge of the display screen. A negative value setting (e.g., −1 to −16) for a z-axis value may correlate to visually appearing to be behind the edge of the display screen. A value of −1 may visually appear to be just behind the display screen edge while a value of −16 may visually appear to be very much behind the edge of the display screen. Although z-axis setting values between −16 and +16 may be described in examples herein, any value or scale system may be utilized in accordance with the present disclosure.

Some embodiments of the disclosure may provide or refer to a default graphic depth, which can identify a depth location for a graphic. Other embodiments may simply provide a range of depths, allowing the user or the provider some flexibility in choosing how deep a graphic should be. Examples of z-axis setting values within a z-axis profile include a minimum depth for display of the on screen graphic within the 3D environment. For example, a frame with certain 3D video content may warrant a minimum depth for on screen graphics for a portion of a display screen. Such a setting of minimum depth may be configured to always put the on screen graphic at a minimum depth on the display screen. The minimum depth may be the minimum possible depth, such as a value of −16, or it may be the minimum depth provided to avoid eye strain of a viewer, such as a value of −10 for the particular frame of 3D video content. Other examples include a maximum depth for display of the on screen graphic, a zero depth, e.g., at the edge of the display screen, a halfway between minimum and zero depth, a halfway between maximum and zero depth, and any number in between.

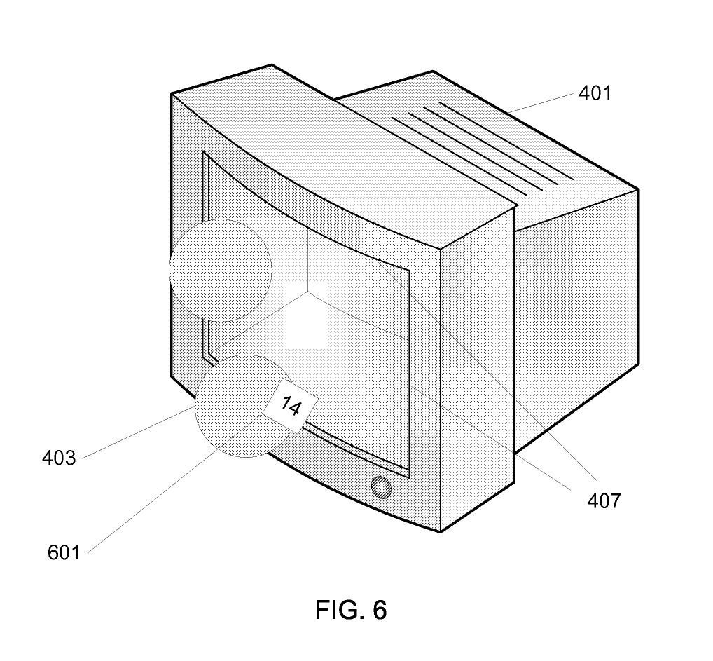

In some embodiments, an onscreen graphic element may span across multiple regions in the profile matrix, and those regions may have different depth values in the matrix. In such embodiments, the display device may select a single depth value for the element, and use that same depth value for the entire element. The single depth value may be determined, for example, by identifying a central or main point for the graphic element (e.g., a center position, a top-left corner or origin point, etc.), and using that point's depth value from the profile matrix. As such, the entire on screen graphics element may be at one depth. FIG. 6 illustrates such an illustrative example. As shown, a display device 401 is rendering 3D video content 403 at a certain z-axis depth, such as +12 on a scale of −16 to +16 where 0 may be the edge of the display screen 407. In this example, on screen graphics 601 may be a channel number. Because the z-axis setting for the on screen graphics 601 is set to a depth closest to adjacent 3D video content 403 depth while maintaining a static depth for the entire on screen graphics, on screen graphics 601 may appear as a single plane of graphics while underlying 3D video content 403 may bow out or appear to sink inward behind it. As should be understood, different on screen graphics rendered at the same time could still have different z-axis depths with respect to each other and any underlying 3D video content.

Alternative examples can let the graphics depth vary across different regions of the screen, and may include a depth closest to adjacent 3D video content depth without maintaining a static depth for an entire graphics plane. In such an example profile, on screen graphics would be positioned to the same depth as the depth of the closest 3D video content and this depth would not be maintained for the entire on screen graphic. Therefore different portions of the on screen graphics may have different depths from other portions where the closest adjacent 3D video content depth is different. As such, the entire plane of the on screen graphics is at one depth.

Still other examples include an average of the 3D video content depth and a maximum depth, and an average of the 3D content depth and a minimum depth. For example, the maximum allowed z-axis depth for 3D video content for a particular region of a display screen may be +8 on a scale of −16 to +16 while the actual depth of the 3D video content for that same particular region may be +4. In such an illustrative example, if the z-axis setting may be chosen as an average of the 3D video content depth and a maximum depth, and an average of the 3D content depth and a minimum depth, the z-axis depth for the particular region of the display screen may be the average of +8, the maximum depth, and +4, the 3D video content depth, which would be +6. As such, any on screen graphics in that particular portion of the display screen would have a z-axis depth of +6.

Having different z-axis setting profiles allows a provider or user to modify her experience quickly. The user may want to set specific on screen graphics at different depths, such as channel number, volume bar, electronic information guide, closed captioning text, etc.

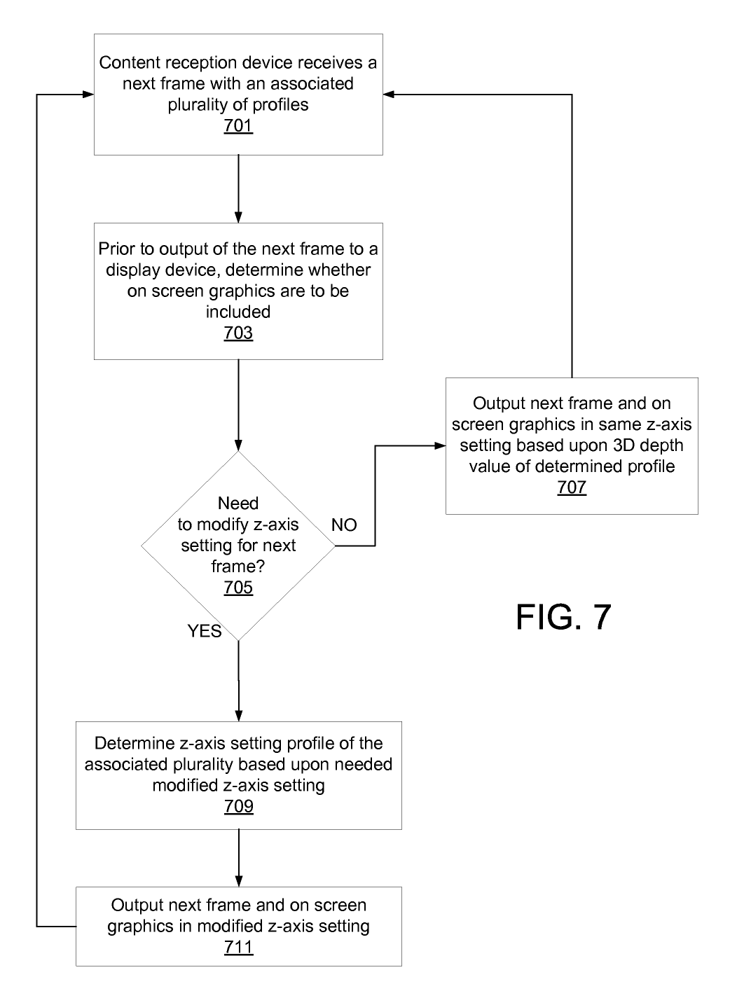

FIG. 7 is an illustrative flowchart of a method for modifying viewer experience settings in a 3D environment in accordance with one or more features of the disclosure herein. At 701, a content reception device receives a next frame of 3D video content with an associated plurality of profiles. The content reception device may be gateway 202 or a display device, as described in FIGS. 2 and 3, for example. A system transmitting the next frame of 3D video content with the associated plurality of z-axis setting profiles for the frame may be a video service system configured to transmit 3D video content received from a 3D content source, such as 3D content source 100 in FIG. 1. The next frame of 3D video content may, for example, be included as a video stream transmission of 3D video content. The associated plurality of z-axis profiles may be embedded in a video stream transmission that includes the next frame of 3D video content. The plurality of z-axis profiles for a respective frame of 3D video content may be part of the video file or it may be a separate file or files that track the video.

In 703, prior to output of the next frame to a display device associated with the content reception device (the reception device and the display device may be part of one physical device or separate devices), a determination may be made as to whether on screen graphics currently are to be included. On screen graphics, such as closed captioning text, electronic program guide displays, control menus, etc., may be included in response to a request by a viewer of the display screen associated with the content reception device to view closed captioning text on the display screen, or if a provider of the content has included graphics to be displayed with the content. A viewer may sit down and decide that things, such as particular images, are too close to her face, or a guest may want to set the 3D experience to be really immersive and intense. Upon a user selecting a particular profile configuration, such as by entry via a remote control through a user interface to select an option of maximum allowable depth, minimum allowable depth, average of a maximum depth and a current 3D video content depth, an average of a minimum depth and a current 3D video content depth, the profile portion corresponding to the selected particular entry, e.g., the second portion, may be utilized for rendering on screen graphics with 3D video content. This selection by a user may be performed as part of an initial configuration of settings for a television screen and/or may be performed at other times, such as when first watching video content and/or while watching video content.

Proceeding to 705, a determination may be made as to whether a need exists to modify the z-axis setting for the next frame received in 701. If there is no need to modify the z-axis setting for the on screen graphics, the process moves to 707 where the next frame received in 701 and on screen graphics in z-axis setting based upon 3D depth value, of the previous determined profile, for example, are outputted to the display screen associated with the content reception device. The process then may return to 701 for a next frame of 3D video content.

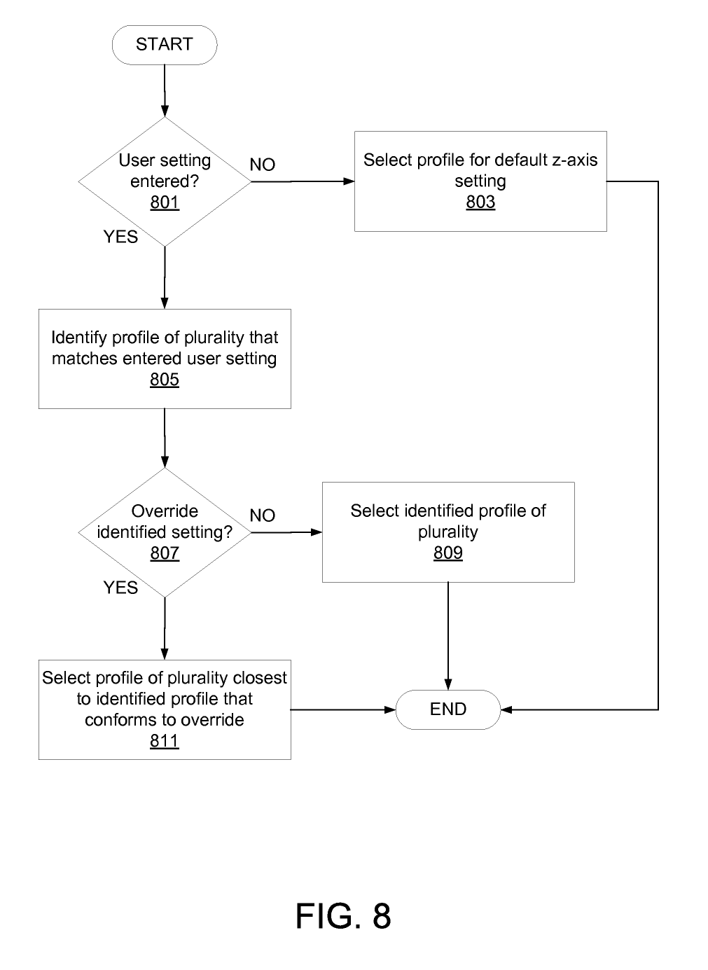

If there is a need to modify the z-axis setting for the on screen graphics in 705, the process moves to 709 where a z-axis setting profile of the associated plurality of z-axis setting profiles may be determined to utilize for display of the on screen graphics with the next frame received in 701. As described below, any of a number of different parameters may be utilized in determining which z-axis setting profile of the plurality is to be utilized in 709. Refer now to FIG. 8, which illustrates a flowchart of an example method for determining a profile with a z-axis setting of a plurality profiles to use with an associated frame of 3D video content. At 801a determination is made as to whether a user setting has been entered. Such a user setting may correlate to a desire of the user to have on screen graphics rendered a certain way with 3D video content. Such examples include having on screen graphics rendered with a z-axis depth always equal to adjacent 3D video content, rendered with a z-axis depth always in front of adjacent 3D video content, rendered with a z-axis depth always set at a depth of 0, where 0 appears to have a depth right at the edge of a display screen of an associated display device, and rendered with a z-axis depth that makes the on screen graphics appear to fade away into the distance over time, e.g., decreases in depth value over time. Examples of such types of user customizable settings are described in more detail below. Any of these types of user customizable settings as described herein alternatively and/or concurrently may be implemented by a content provider and/or automatically implemented by a device either in the home or elsewhere in a network.

If no user setting has been entered, the process may proceed to 803 where a profile of the plurality of profiles that correlates to a default z-axis setting may be selected by the system. As such, any associated on screen graphics are later rendered with 3D video content at a z-axis setting that is a default setting based on the onscreen region and the region's depth value in the profile matrix shown in FIGS. 5A & B, e.g., asset the z-axis depth of on screen graphics in a screen region to be the z-axis depth of the region's matrix depth setting plus 1, i.e., appearing in front of any adjacent 3D video content. Such an example of on screen graphics 601 rendered with adjacent 3D video content 403 is shown in FIG. 6. If a user setting has been entered in 801, the process may proceed to 805 where a profile of the plurality of profiles that matches the entered user setting may be identified by the system. For example, if the user chose a z-axis setting of always at a depth 0, the profile of having all on screen graphics with a z-axis depth of 0 may be identified.

Moving to 807, a determination may be made as to whether an override to the identified profile is needed. Such a situation may arise when a user setting conflicts with a maximum allowable setting to prevent eye strain. If an override to the identified profile is not needed, the process may move to 809 where the identified profile of the plurality of profiles in 805 is selected for use in rendering on screen graphics with 3D video content for a frame. If an override to the identified profile is needed in 807, the process may move to 811 where a profile of the plurality of profiles closest to the z-axis settings of the identified profile that conforms to the override may be selected by the system. As such, the system may select the profile that most closely matches the user entered setting while still conforming to a prevention of eye strain for a user. Returning to FIG. 7, in 711, the next frame received in 701 and on screen graphics in z-axis setting based upon 3D depth value of the determined profile in 709 are outputted to the display screen associated with the content reception device.

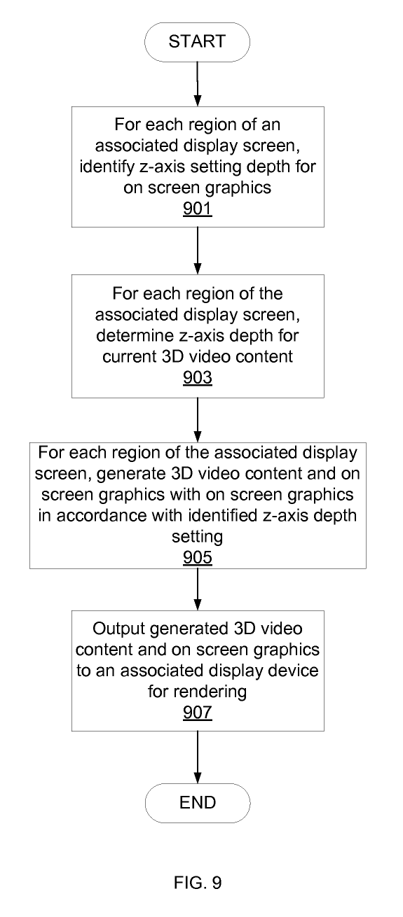

FIG. 9 illustrates a flowchart of an example method for outputting 3D video content with on screen graphics in accordance with a selected profile of z-axis settings. At 901 a z-axis setting depth for on screen graphics included within a selected profile is identified. This identification may be for each region of an associated display screen, such as the example provided in FIGS. 5A and 5B. In 903, a z-axis depth for current 3D video content for a frame may be determined for each region of the associated display screen. As such, following 903, the desired z-axis depth of on screen graphics and the identified z-axis depths for 3D vide content of a frame are known.

Proceeding to 905, 3D video content and on screen graphics with on screen graphics in accordance with the identified z-axis depth setting in 901 may be generated. This generation may occur for each region of the associated display screen. As such, a video image for rendering on a display device has been generated. This video image includes the original 3D video content and the on screen graphics at the z-axis depth in accordance with the selected profile. Then, in 907, the generated 3D video content and on screen graphics may be outputted to an associated display device for rendering. Such a display device may, for example, be a television, such as television 204 in FIG. 2.

Returning to FIG. 7, following 711, the process may return to 701 where the content reception device receives a next frame with a new plurality of z-axis setting profiles associated with the next frame. This new plurality of z-axis setting profiles may include one or more profiles as in the plurality received for a previous frame in addition to additional and/or fewer profiles.

In one example for the process of 709, aspects of the disclosure include examples in which default settings for z-axis settings for on screen graphics are implemented. In such a case, the system may determine a default z-axis setting for all on screen graphics in a particular region of a display screen as the same z-axis depth or may have a different default z-axis setting per type of on screen graphic at a particular region of a display screen. One example includes making the default z-axis setting as the z-axis setting determined by the system to cause the least eye strain for a viewer/user. For example, if a portion of 3D video content within a frame has a z-axis setting value of +16 and it is adjacent to an on screen graphic for display, the system may determine the least eye strain for a viewer as a z-axis setting value of +16 for the on screen graphic. The system may determine that rendering an on screen graphics at an extreme difference in depth, such as at a value of −16, in comparison to the depth of adjacent 3D video content, such as at a value of +16, may cause eye strain to a viewer due the severe difference in depths. Therefore, the default z-axis setting for that particular frame may be a profile with a depth value of +16. A user/viewer may change a default z-axis setting for output of on screen graphics with 3D video content. This change by a user may initiate the process of FIG. 7 from 705 to 709.

Z-axis settings for on screen graphics within a 3D environment may be modified for any of a number of additional reasons. Z-axis settings for on screen graphics may be modified because of a region on the display screen for display of the on screen graphics, a change in time, and even the current 3D video content being displayed. Although FIG. 7 is described with respect to modifying a z-axis setting of on screen graphics due to a change in default setting, a rendering region of the on screen graphics on a display screen, a change over time, and/or a current 3D video content associated with a frame with the on screen graphics, other parameters may be taken into account for modification of on screen graphics in a 3D environment.

The determined profile in 709 of FIG. 7 with the z-axis setting may be based on a rendering region of the requested on screen graphic on the display device. The determination in 705 may be a determination as to whether a need exists to modify the z-axis setting for the next frame because of the rendering region of the requested on screen graphic on the display screen. The z-axis setting profile may be determined in 709 based upon a rendering region of the on screen graphic on the display screen. For example, regions near an edge of a display screen may have a maximum and/or minimum depth value of 0 on a scale of −16 to +16. Such may be the case in order to decrease a likelihood of eye strain on a viewer. Rendering 3D graphics near the edge of a display screen is known to cause eye strain and fatigue for a viewer. As such, the system may be configured to render on screen graphics in certain regions around the edge of a display screen where it meets of a frame of the display device to be appear right at the display screen surface, e.g., at a z-axis depth of 0 on a scale of −16 to +16.

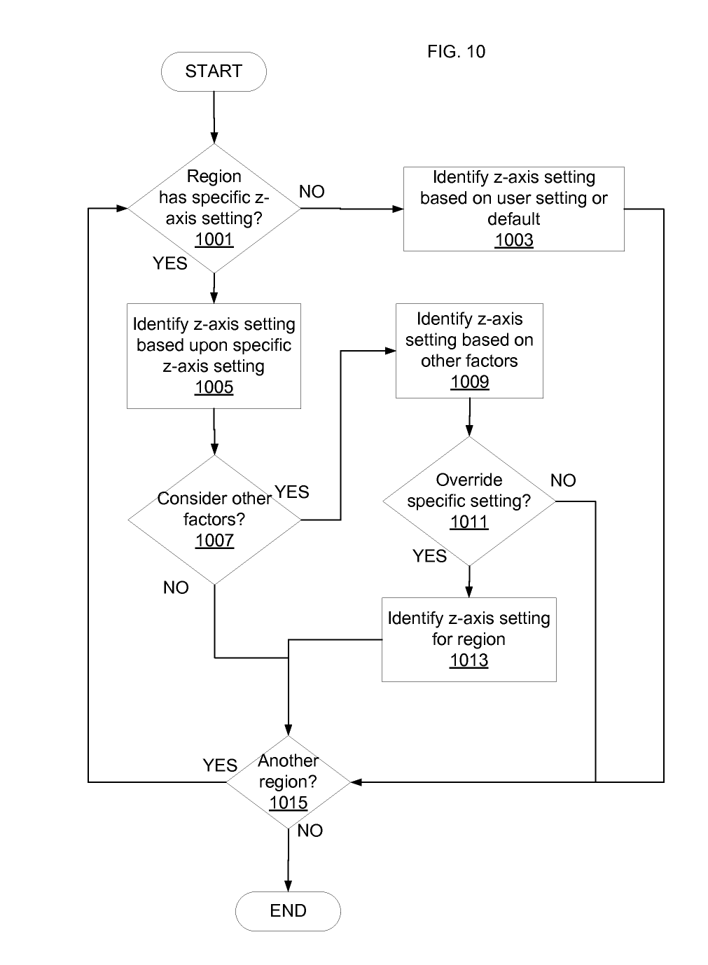

FIG. 10 illustrates a flowchart of an example method for determining a profile of a plurality of profile for rendering 3D video content with on screen graphics in accordance with a particular region of a display screen. The process starts and at 1001, a determination may be made as to whether a particular region of a display screen has a specific z-axis setting for that location. For example, if the region in question is near an edge of the display screen, a maximum z-axis setting may be in place for rendering of on screen graphics in that region. If such is the case, the process moves to 1005. If there is not specific z-axis setting for that location, the process may move to 1003 where a z-axis setting for the region is identified based upon a default setting or a setting entered by a user. The process then proceeds to 1015 where another region may be addressed.

In 1005, a z-axis setting based upon the specific z-axis setting requirements of the particular region may be identified. As previously described, such a situation may arise near an edge of a display screen. Extremely positive or extremely negative depth values along an edge or another portion of a display screen may cause eye strain for a viewer. As such, the region near a display edge (or such other portion) may be configured to have a specific z-axis setting for on screen graphics of 0 on a scale of −16 to +16. Proceeding to 1007, a determination may be made as to whether other considerations need to be taken into account for the z-axis setting. For example, a viewer may have set a user setting for time as described above so that the on screen graphics appear to fade away. In such a case, the process moves to 1009 where the z-axis setting based upon one or more other factors may be identified. Then to process moves to 1011. If no other considerations need to be taken into account for the z-axis setting in 1007, the process moves to 1015 where another region may be addressed.

In 1011, a determination may be made as to whether to override the identified z-axis setting in 1005 with the identified z-axis setting in 1009. If there is no override of the specific z-axis setting identified in 1005, the process moves to 1015 where another region may be addressed. If the system determines to override the specific setting identified in 1005, the z-axis setting is 1009 is utilized for rendering of on screen graphics for the particular region being addressed. The process may then proceed to 1015 to determine whether another region needs to be addressed. If another region needs to be addressed, the process returns to 1001 for another region.

In another example, the determined profile in 709 of FIG. 7 with the z-axis setting may be based on a period of time. The determination in 705 may be a determination as to whether a need exists to modify the z-axis setting for the next frame because of a change in time. For example, when a system first displays an electronic guide on a display device, the on screen graphics of the electronic guide may start at a z-axis setting depth value of 0 on a scale of −16 to +16. Over time, the on screen graphics of the electronic guide slowly may move out of the display screen, e.g., appear to project out of the display screen by increasing in z-axis setting depth value, or the on screen graphics of the electronic guide slowly may fade into the display screen, e.g., appear to fade away back into the display screen by decreasing the z-axis setting depth value.

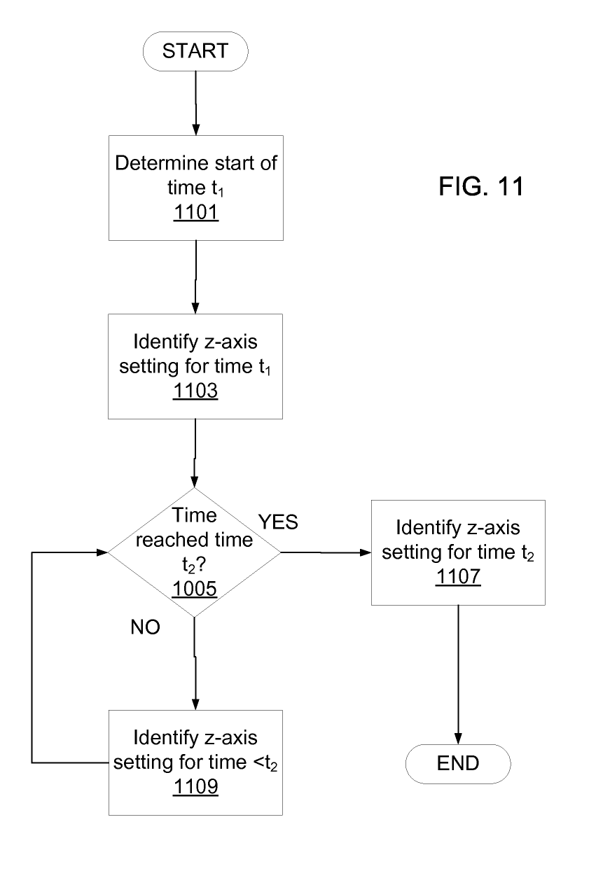

FIG. 11 illustrates a flowchart of an example method for determining a profile of a plurality of profiles for rendering 3D video content with on screen graphics in accordance with a change in time. The process starts and at 1101, the system may determine the start of time t₁. Such an example may be the start of a clock or counter. In 1103, a z-axis setting may be determined for rendering of on screen graphics with 3D video content based upon time t₁. In the example of an on screen graphic fading away, time t1 may correlate to a first z-axis setting where the on screen graphic is projected toward a viewer, such as a z-axis setting of +16 on a scale of −16 to +16. Proceeding to 1105, a determination may be made as to whether time has reached time t₂. If time t₂ has not been reached, the process may proceed to 1109 where a z-axis setting may be determined for rendering of on screen graphics with 3D video content based upon time less than t₂. This identified z-axis setting in 1109 may be the same as the identified z-axis setting in 1103. In the previous example of a fading on screen graphics, the failure to reach time t₂ may correlate to maintaining the same z-axis depth setting for the on screen graphics until time t₂ is reached.

If time t₂ is reached in 1005, the process moves to 1007 where a z-axis setting may be determined for rendering of on screen graphics with 3D video content based upon time t₂. In the previous example of a fading on screen graphics, reaching time t₂ may correlate to utilizing a z-axis depth setting of lesser depth value than was utilized for time t₁. In an example where a z-axis setting for time t₁ is +16, the z-axis setting for time t₂ may be +8, making an on screen graphic appear to fade away. Although not shown in the example of FIG. 11, the process may continue for subsequent times for more fading and/or other transitions, such as an on screen graphics bowing out and then fading away.

In yet another example, the determined profile in 709 of FIG. 7 with the z-axis setting may be based on the current content of the 3D video content in the next frame. The determination in 705 may be a determination as to whether a need exists to modify the z-axis setting for the next frame because of the current 3D video content of the frame. For example, when a system displays a first frame with a channel number of on screen graphics on a display device, the on screen graphics of the channel number may be at a z-axis setting depth value of 0 because adjacent 3D video content to the channel number on screen graphics are being displayed at a z-axis depth value of 0. Then, for a next frame, the adjacent 3D video content to the channel number on screen graphics may change its z-axis depth value to +10. Accordingly, the on screen graphics of the channel number for that next frame may be modified to have a z-axis setting depth value of +10 as match.

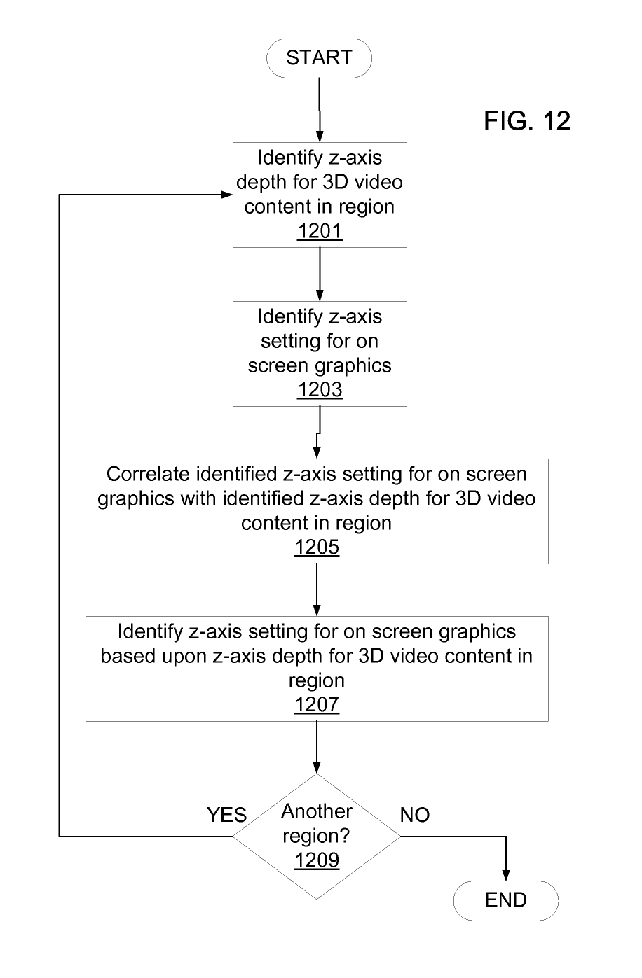

FIG. 12 illustrates a flowchart of an example method for determining a profile of a plurality of profiles for rendering 3D video content with on screen graphics in accordance with the current 3D video content. The process starts and at 1201 a z-axis depth for 3D video content of a particular region of a display screen may be determined. Such an example may be a frame of 3D video content where the upper right hand corner of the 3D video content has an object bowing out toward a viewer, e.g., has a depth value of +16 on a scale of −16 to +16. In 1203, a z-axis setting may be determined for rendering of on screen graphics with the 3D video content. The identification may be a z-axis setting for a channel number to be rendered in the upper right hand corner of a display screen. In the previous example where 3D video content in the upper right hand corner is bowing out toward a viewer, e.g., has a z-axis setting value of +16, the on screen graphics may be identified as having a z-axis setting of match the current 3D video content. Proceeding to 1205, the identified z-axis setting for on screen graphics in 1203 may be correlated with the identified z-axis depth for 3D video content in a region in 1201. In the previous example of a channel number, the z-axis setting for the on screen graphics may be identified as +16 to match the z-axis depth value for the current 3D video content in the region. In 1209, the z-axis setting for on screen graphics based upon z-axis depth for 3D video content in the region may be identified based upon this correlation.

Additional illustrative parameters for a z-axis setting for on screen graphics may be utilized. For example, a user may set a z-axis setting for a particular speed for fading when based upon time. A user may change a speed from very slow fading, to slow fading, to intermediate fading, to fast fading, to very fast fading. In other examples, a user may choose to have the on screen graphics fade different ways, such as toward the viewer, up, down, left, right, etc. In another example, a user may set a z-axis setting to prioritize the basis for the setting. For example, a user may specify a z-axis setting to be based on the particular region of the display screen first and, if not a factor, e.g., not near an edge of the display screen, then based on a current 3D video content in the region. Still other example basis for choosing a z-axis setting for rendering of on screen graphics with 3D video content may be implemented.

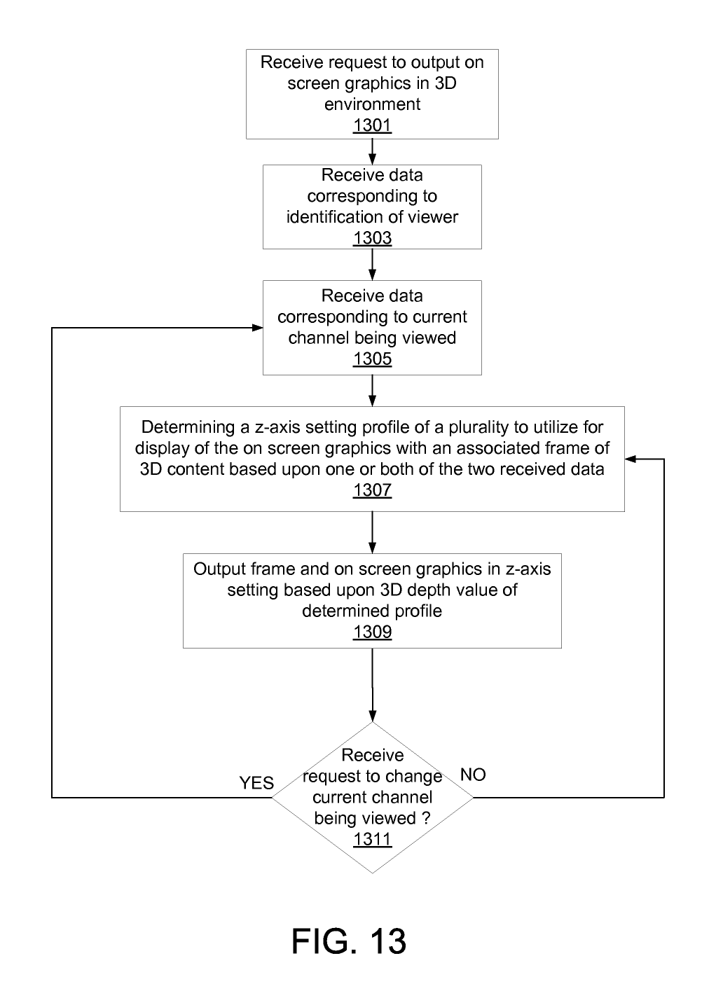

A system may modify z-axis settings for on screen graphics due to other parameters, such as an identified viewer/user and/or a current channel of 3D video content being viewed. FIG. 13 is another illustrative flowchart of a method for modifying viewer experience settings in a 3D environment in accordance with one or more features of the disclosure herein. In 1301, a request to output on screen graphics in a 3D environment to a display screen may be received. In 1303, data corresponding to identification of a viewer may be received. Such data may be received by the viewer inputted information to a content reception device, such as via a remote control. Such data also may be received by biometrically determining the viewer. Such a determination may be based upon scanning a biometric parameter of the viewer and correlating the scanned data against known data to determine is a match exists. Any of a number of manners for receiving such data may be utilized in accordance with the present disclosure. Proceeding to 1305, data corresponding to the current channel of 3D video content being viewed may be received. Any of a number of manners for determining such data may be utilized in accordance with the present disclosure including determining the tuner setting.

In 1307, a z-axis setting profile, of a plurality of z-axis setting profiles associated with a frame of 3D video content, to utilize for display of the on screen graphics with the frame of 3D video content may be determined. The determination of 1307 may be based upon one or both of the data received in 1303 and 1305. Moving to 1309, the frame and on screen graphics in z-axis setting based upon 3D depth value of the determined profile are outputted to the display screen. In 1311, a determination may be made as to whether a request to change the current channel being viewed has been received. If not, the process may return to 1309 and/or 1307. In a request in 1311 has been received, the process moves to 1313.

In 1313, data corresponding to the new current channel being viewed may be received. Such data may correspond to a viewer entering a new channel number via a remote control associated with the display screen. Proceeding to 1315, a second z-axis setting profile, of a new plurality of z-axis setting profiles associated with a next frame of 3D video content, to utilize for display of the on screen graphics with the next frame of 3D video content may be determined. The determination of 1315 may be based upon one or both of the data received in 1303 and 1313. Moving to 1317, the next frame and on screen graphics in a modified z-axis setting based upon 3D depth value of the determined second z-axis profile are outputted to the display screen. Although not shown in FIG. 13, a concurrent or alternative embodiment may include receiving data corresponding to a change of viewer watching a current channel. As such, the system may modify the z-axis setting of on screen graphics based upon the change of viewer.

Other embodiments include numerous variations on the devices and techniques described above. Embodiments of the disclosure include a machine readable storage medium (e.g., a CD-ROM, CD-RW, DVD, floppy disc, FLASH memory, RAM, ROM, magnetic platters of a hard drive, etc.) storing machine readable instructions that, when executed by one or more processors, cause one or more devices to carry out operations such as are described herein.

The foregoing description of embodiments has been presented for purposes of illustration and description. The foregoing description is not intended to be exhaustive or to limit embodiments of the present disclosure to the precise form disclosed, and modifications and variations are possible in light of the above teachings or may be acquired from practice of various embodiments. Additional embodiments may not perform all operations, have all features, or possess all advantages described above. The embodiments discussed herein were chosen and described in order to explain the principles and the nature of various embodiments and their practical application to enable one skilled in the art to utilize the present disclosure in various embodiments and with various modifications as are suited to the particular use contemplated. The features of the embodiments described herein may be combined in all possible combinations of methods, apparatuses, modules, systems, and machine-readable storage media. Any and all permutations of features from above-described embodiments are the within the scope of the disclosure.

1. A method comprising:
determining, by a computing device, a z-axis depth to utilize for display of on screen graphics associated with 3D video content;
generating signals representing the 3D video content comprising the on screen graphics at the z-axis depth; and
outputting the generated signals.

2. The method of claim 1, further comprising receiving, at the computing device, the 3D video content and a plurality of z-axis setting profiles associated with the 3D video content, wherein the determining comprises determining the z-axis depth from a profile of the plurality of profiles.

3. The method of claim 2, further comprising:
receiving, at the computing device, new 3D video content and a new plurality of z-axis setting profiles associated with the new 3D video content;
determining, by the computing device, whether to modify the z-axis depth for the on screen graphics for the new 3D video content; and
determining, by the computing device, a new z-axis depth to utilize for display of the on screen graphics with the new 3D video content.

4. The method of claim 3, wherein the determining, by the computing device, whether to modify the z-axis depth for the on screen graphics for the new 3D video content is based at least in part upon a rendering location of the on screen graphic on a display device.

5. The method of claim 3, wherein the determining, by the computing device, whether to modify the z-axis depth for the on screen graphics for the new 3D video content is based at least in part upon a change of time.

6. The method of claim 3, wherein the determining, by the computing device, whether to modify the z-axis depth for the on screen graphics for the new 3D video content is based at least in part upon at least one portion of the new 3D video content.

7. The method of claim 1, wherein the z-axis depth is a default z-axis depth.

8. The method of claim 1, wherein the determining, by the computing device, the z-axis depth to utilize for display of the on screen graphics associated with the 3D video content is a z-axis depth of least eye strain for a viewer.

9. The method of claim 2, further comprising receiving data corresponding to an identity of a viewer, wherein the determining the z-axis depth from the profile of the plurality of profiles is based at least in part upon the data corresponding to the identity of the viewer.

10. The method of claim 1, further comprising receiving data corresponding to a current channel of 3D video content being viewed, wherein the determining, by the computing device, the z-axis depth to utilize for display of the on screen graphics associated with the 3D video content is based at least in part upon the data corresponding to the current channel of 3D video content being viewed.

11. One or more non-transitory computer readable media storing computer-executable instructions that, when executed by at least one processor, causes the at least one processor to perform a method of:
determining a z-axis depth to utilize for display of on screen graphics associated with 3D video content;
generating signals representing the 3D video content comprising the on screen graphics at the z-axis depth; and
outputting the generated signals.

12. The one or more non-transitory computer readable media of claim 11, the computer-executable instructions further causing the at least one processor to perform a method of receiving the 3D video content and a plurality of z-axis setting profiles associated with the 3D video content, wherein the determining comprises determining the z-axis depth from a profile of the plurality of profiles.

13. The one or more non-transitory computer readable media of claim 12, the computer-executable instructions further causing the at least one processor to perform a method of:
receiving new 3D video content and a new plurality of z-axis setting profiles associated with the new 3D video content;
determining whether to modify the z-axis depth for the on screen graphics for the new 3D video content; and
determining a new z-axis depth to utilize for display of the on screen graphics with the new 3D video content.

14. The one or more non-transitory computer readable media of claim 13, wherein the determining whether to modify the z-axis depth for the on screen graphics for the new 3D video content is based at least in part upon at least one of: a rendering location of the on screen graphic on the display device, a change of time, and at least one portion of the new 3D video content.

15. The one or more non-transitory computer readable media of claim 12, the computer-executable instructions further causing the at least one processor to perform a method of receiving data corresponding to an identity of a viewer, wherein the determining the z-axis depth from the profile of the plurality of profiles is based at least in part upon the data corresponding to the identity of the viewer.

16. An apparatus comprising:
at least one processor; and
at least one memory, the at least one memory storing computer-executable instructions that, when executed by the at least one processor, causes the at least one processor to perform a method of:
determining, by a computing device, a z-axis depth to utilize for display of on screen graphics with 3D video content based upon the 3D video content;
generating a video image of the 3D video content and the on screen graphics at the z-axis depth; and
outputting, to a display device, the generated video image.

17. The apparatus of claim 16, the computer-executable instructions further causing the at least one processor perform a method of receiving the 3D video content and a plurality of z-axis setting profiles associated with the 3D video content wherein the determining includes determining the z-axis depth from a profile of the plurality of profiles.

18. The apparatus of claim 17, the computer-executable instructions further causing the at least one processor perform a method of:
receiving new 3D video content and a new plurality of z-axis setting profiles associated with the new 3D video content;
determining whether to modify the z-axis depth for the on screen graphics for the new 3D video content; and
determining a new z-axis depth to utilize for display of the on screen graphics with the new 3D video content.

19. A method comprising:
receiving, at a central location, a plurality of signals representing 3D video content and at least one z-axis setting profile, each of the at least one z-axis setting profile having an associated a z-axis depth value for display of on screen graphics;
generating a video stream comprising the at least one z-axis setting profile with the plurality of signals representing 3D video content into a video stream; and
transmitting the video stream.

20. The method of claim 19, wherein the at least one z-axis setting profile includes a matrix of z-axis depth values for different regions a display screen associated with a customer premises.

21. The method of claim 19, wherein the on screen graphics are on screen graphics locally generated at a customer premises.
